(19) United States
(12) Patent Application Publication
(10) Pub. No.: US 2008/0263864 A1
(43) Pub. Date: Oct. 30, 2008

(54) TURBOMACHINE BLADE AND TURBOMACHINE COMPRISING THIS BLADE

(75) Inventors: Christelle FOUCHER, Cesson (FR); Claude Marcel Mons, Savigny Le Temple (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, PARIS (FR)

(21) Appl. No.: 12/110,592

(22) Filed: Apr. 28, 2008

(30) Foreign Application Priority Data
Apr. 30, 2007 (FR) 07 03125

(51) Int. Cl. B23P 6/00

(52) U.S. Cl. 29/889.1; 205/50

(57) ABSTRACT

The present invention relates to a resurfacing method of repairing a surface portion of a moving turbomachine blade. The method is noteworthy in that metal particles are deposited on said surface by electrolysis. The latter is of the type comprising pad electrolysis, electrolysis in a bath or microbath, or a combination thereof.

The present invention is advantageously applied to the resurfacing of blade root surface portions made of titanium or a titanium alloy that are worn by friction.

### BACKGROUND OF THE INVENTION

The present invention relates to the field of turbomachines and in particular the repair of a blade having a worn area on a surface portion, more particularly a portion located in the area of the root.

### DESCRIPTION OF THE PRIOR ART

A turbo engine having a bypass gas turbine comprises a fan rotor consisting of a plurality of blades mounted on the rim of a disk driven by the shaft of the low-pressure rotor of the gas generator. The fan blades, which are made of titanium or a titanium alloy, are retained in individual cavities generally oriented in the axial direction of the machine. The root of the blades has a shape with dovetail cross section, complementary to the cavities that accommodate them. According to one type of machine, the blades are extended downstream by an axial protuberance via which the blade is immobilized in the cavity. An example is described in the patent EP 165 860 in the name of the present Applicant. The blade is immobilized axially by a downstream lock ring against which it also bears axially. The ring may be formed from a flange of the rotor of the downstream compressor. Because of vibrational movements in operation, the root is subjected to repeated shocks and to rubbing against the surfaces on which it bears, which result in wear and loss of material in that are of the root facing downstream. When the wear reaches a certain threshold, the part has to be replaced. Hitherto, the parts were scrapped or else stored awaiting repair, no known method giving a satisfactory result.

To resurface a surface portion of the blade by welding is difficult since the reduction in fatigue strength caused by heating the part is very substantial and not acceptable at the base of a fan blade airfoil.

Furthermore, the substantial wear observed, sometimes more than 0.5 mm, and the size of the worn area, of around 1 to 2 cm², make the application of a thermal spraying resurfacing method very tricky. This method is always possible, but there is a risk of loosing the coating by spalling. This results in a maximum permitted thickness for repair that remains insufficient for the most extensively worn areas encountered on these parts.

Moreover, the part on which the blade bears is also made of titanium. Contact between titanium surfaces excludes most coatings.

The particular conditions in this area are the following:
high oligo-cyclic stresses, implying the use of a resurfacing method that does not affect the fatigue strength;
contact pressure poorly distributed and centrifugal shear implying good adhesion of the resurfacing layer; and
contact with titanium requiring an appropriate resurfacing material.

### SUMMARY OF THE INVENTION

The subject of the invention is therefore a repair method that does not have the drawbacks of the know methods of repairing turbomachine parts and allows the specific problems associated with resurfacing a surface portion, such as a titanium fan blade root or foot, to be solved.

According to the invention, the resurfacing method of repairing a surface portion of a moving turbomachine blade made of titanium or a titanium alloy is noteworthy in that it includes at least one step in which nickel, cobalt or a combination of the two metals is deposited on said surface portion by electrolysis.

According to one particular method of implementation, the metal deposition is carried out in at least two steps, combining pad electrolysis with electrolysis in a bath or a microbath.

The method of the invention allows worn parts to be repaired by resurfacing over relatively large depths, of the order of 1 mm, but over small areas. This is for example the case for a fan blade having a root with a dovetail cross section, part of the downstream face of the root of which is worn.

Such a method has the advantage of not affecting the fatigue potential of the substrate. Furthermore, it has been found that in the case of wear by friction against titanium parts the behavior of the repaired part is better than the initial configuration.

The metal particles of the electrolyte comprise nickel, cobalt or a combination of the two metals—for example nickel sulfamate.

The method allows a metal layer of between 10 μm and 1 mm to be deposited.

In respect of its advantageous properties, the invention also relates to a moving turbomachine fan blade made of titanium or a titanium alloy having a dovetail-shaped root and an axial surface bearing portion. The blade is noteworthy in that said axial bearing surface is at least partially covered with a metal coating deposited electrolytically and the metal coating comprises nickel, cobalt or a combination of the two.

### BRIEF DESCRIPTION OF THE DRAWINGS

Non-limiting embodiments of the invention will now be described in greater detail with reference to the drawings in which:

FIG. 1 shows in axial cross section a fan blade mounted on a turbomachine rotor disk;

FIG. 2 shows a cross-sectional view along the direction 2-2 of FIG. 1;

FIG. 3 shows the diagram of a pad electrolysis installation for resurfacing a surface portion, such as the root of the blade of FIG. 2;

FIG. 4 shows the diagram of an installation for resurfacing by electrolysis in a bath, and

FIG. 5 shows the diagram of an installation for resurfacing by electrolysis in a microbath.

### DESCRIPTION OF THE PREFERRED EMBODIMENTS

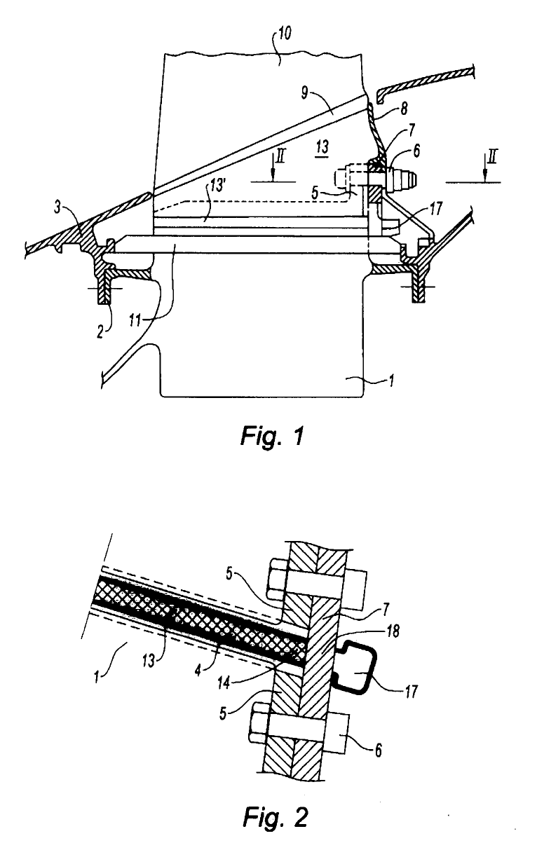

FIG. 1 shows an arrangement as described in patent EP 165 860. This figure shows a disk 1 of a turbo engine rotor having a flange to which a conical front cowl 3 is fastened. Approximately axial cavities 4 are machined in the rim of the disk 1 by broaching. Their cross section is in the form of a dovetail and corresponds to the shape of the lower part 13′ of the root 13 of the blades 10. The root 13 is that part of the blade 10 below the platform 9 that delimits the gas stream. The blade is locked inside the cavity by a key 11 slid over the lower part 13′ of the root 13. On the downstream face, the rim of the disk has a radial flange 5 for fastening a lock ring 7 and a sealing ring 8 by means of bolts 6.

The lock ring 7 has the same number of radially inward recesses 18 as there are cavities, these facing the latter. The lower part 13′ of the blade roots 13 is moreover extended over the rear part by an axial protuberance 17, said protuberance being provided laterally with two notches. The protuberances are engaged in the recesses 18, the flanks of which are guided inside the lateral notches of the protuberance.

The lock ring 7 thus at least partially masks the downstream end of the cavities 4.

The rear part of the blade root 13 is in abutment on a surface portion 14 against the lock ring 7 between two bolts 6. Because of the vibrations of the engine in operation, the surface portion 14 rubs against the surface of the lock ring and undergoes substantial wear with loss of material. As mentioned above, this type of surface portion is difficult to repair. No satisfactory solution exists in the current state of the art.

In accordance with the invention, this type of surface portion is repaired by material resurfacing. The repair consists in forming a metal layer that not only makes up for the material deficit but also makes the surface more wear-resistant.

The resurfacing metal product is, according to the invention, deposited on the worn surface by pad electrolysis, by electrolysis in a bath or electrolysis in a microbath.

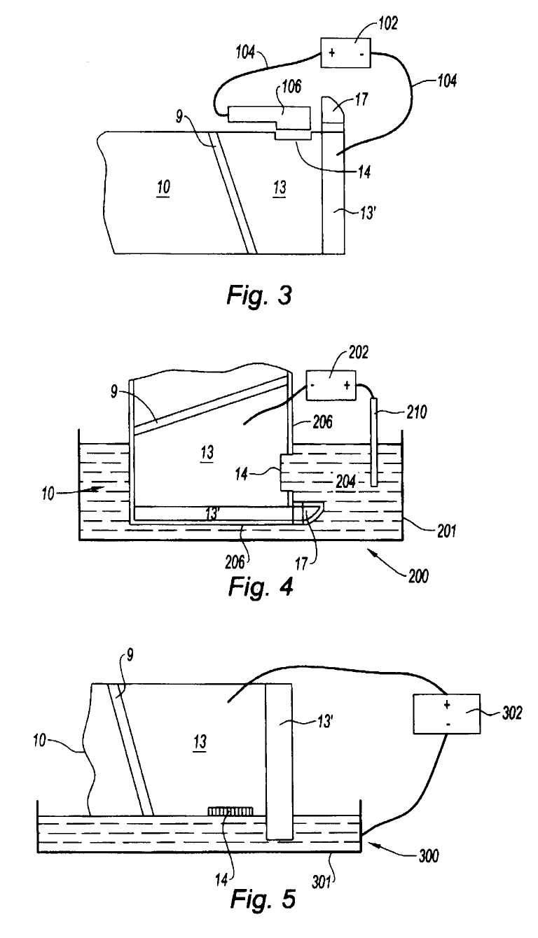

FIG. 3 shows schematically a pad electrolysis resurfacing installation. The device 100 comprises an electric current source 102 connected by conductors 104 to the blade 13 forming the cathode and to a pad 106 that forms the anode and is impregnated with an electrolyte solution. The pad is for example a graphite electrode and its geometry and dimensions are adapted to the shape and dimensions of the surface portion to be treated. The electrolyte solution may be a nickel sulfamate solution for depositing nickel.

In FIG. 4, the metal resurfacing product is deposited by electrolysis in a bath. The installation 200 comprises a tank 201 filled with an electrolyte solution 204 in which the blade root 13 is at least partially immersed, only the surface portion 14 to be treated of said blade root being in contact with the electrolyte solution. The rest of the blade is protected by suitable means, such as adhesive tapes 206. The blade is connected to an electric current source 202 to form the cathode, and an electrode 210 is immersed in the electrolyte solution and connected to the current source 202 to form the anode. As in the previous solution, it is possible to use a graphite electrode 210 and nickel sulfamate as electrolyte solution.

In FIG. 5, the metal product is deposited by electrolysis in a microbath by means of an installation 300 comprising a tank 310 which is shaped so as to accommodate the blade 1 and an electrolyte solution which is in contact with the blade only in that part of the surface having a material deficit. An electric current source 302 is connected to the blade 13 to form the cathode, and to the tank 301 to form the anode.

Optionally, the surface of the blade thus repaired may be machined so as to return to the initial shape. The layer formed may also if necessary serve as a sublayer for a coating deposited by another means, which may be another form of electrolysis.

For example, a first layer formed by pad electrolysis may serve as a sublayer for deposition using another electrolysis technique, such as deposition by electrolysis in a bath.

1. A resurfacing method of repairing a surface portion of a moving turbomachine blade made of titanium or a titanium alloy, wherein nickel, cobalt or a combination of the two metals is deposited on said surface portion by electrolysis.

2. The method as claimed in the preceding claim, wherein the metal deposition is carried out by pad electrolysis.

3. The method as claimed in claim 1, wherein the metal deposition is carried out by electrolysis in a bath.

4. The method as claimed in claim 1, wherein the metal deposition is carried out by electrolysis in a microbath.

5. The method as claimed in claim 1, wherein the metal deposition is carried out in at least two steps combining pad electrolysis with electrolysis in a bath or microbath.

6. The method as claimed in the preceding claims applied to a fan blade.

7. The method as claimed in the preceding claim, wherein the electrolyte comprises nickel sulfamate.

8. The method as claimed in one of the preceding claims, wherein a metal layer of between 10 μm and 1 mm is deposited.

9. The resurfacing repair method as claimed in one of the preceding claims, said surface portion being located on the root of the blade.

10. The resurfacing method as claimed in the preceding claim, the root of the blade having a dovetail cross section and said surface portion being an axial bearing surface portion of the blade.

11. A moving turbomachine blade having a dovetail root and an axial bearing surface, wherein said axial bearing surface is at least partially covered with a metal coating deposited electrolytically.

12. The blade, made of titanium or a titanium alloy, as claimed in the preceding claim, the metal coating of which comprises nickel, cobalt or a combination of the two.

13. A turbomachine having a blade as claimed in either of claims 11 and 12.
